(19) United States
(12) Patent Application Publication
(10) Pub. No.: US 2005/0178755 A1
(43) Pub. Date: Aug. 18, 2005

(54) Air-conditioning method and device for vehicle seats and components

(76) Inventor: Thomas Ulbrich, Erdweg (DE)

Correspondence Address: Robert P. Renke;Suite 250, 28333 Telegraph Road, Southfield, MI, 48034, US

(21) Appl. No.: 11/033,694

(22) Filed: Jan. 12, 2005

(30) Foreign Application Priority Data
Jan. 12, 2004 (DE) 10 2004 001 777.8

(51) Int. Cl. F28F 1/00; B60H 1/00; B60L 1/02

(52) U.S. Cl. 219/202; 165/41; 165/202

(57) ABSTRACT

An air-conditioning device (10) and an air-conditioning method for components of a vehicle interior, in particular for a vehicle seat (12), having a ventilating mechanism (14) for producing an air flow and having at least one air duct (16) for connection to an air outlet (18) of the component. The air duct (16) has a heating mechanism (20) for heating the conveyed air (28).

### TECHNICAL FIELD

The present invention relates to an air-conditioning method and device for vehicle seats and components of a vehicle interior.

### BACKGROUND OF THE INVENTION

Air-conditioning means for vehicle seats or other components of the interior of a vehicle are known in a variety of embodiments. One well known variant of such air-conditioning means comprises a ventilating means for the supply of heated or cooled air to a vehicle seat, which can flow out of suitable areas in the seat surface. When heated air is supplied, it is heated by a heating means that may be located, for example, before or after the ventilating means and usually consists of electrically heatable wires or the like. Hot air blowers are also known.

DE 196 45 544 A1 discloses a vehicle seat that can be air-conditioned. The heatable and/or coolable vehicle seat comprises at least one heating element and one cooling element, which for heating or for cooling the vehicle seat, is capable of connection to a secondary circuit of a heat exchanger which on the primary side is acted on by a heat or cold generator on board the vehicle. The heating element and the cooling element may have hoses or tubes, placed meandering according to a specified embodiment, through which the respective fluid flows.

Instead of heated or cooled fluid flowing through the lines, the fluid itself in the lines can also be heated. This can be accomplished by providing the lines with suitable heating means, in the form for example of heating wires. An electrically heatable hose of this kind for windshield washer systems is disclosed in DE 299 23 550 U1. In that case, two heating wires provided with electrical connections are located running along a hose wall, the hose at its one end being capable of connection to a water pump and at its other end being connectable with spray nozzles of a washer system. The electrically heatable wires are formed into the hose wall.

In order to avoid a point discharge on the vehicle seat and in order to distribute the heated air in the vehicle seat over a given discharge area, so-called distance-knit fabrics, which may be worked into the cushion, are suitable. A distance-knit fabric for upholstering a vehicle seat is disclosed for example in DE 299 01 225 U1. The distance-knit fabric consists of parallel areal layers of knit fabric and pile thread connecting and holding them at a distance from one another, where conductive filaments, which are formed by at least one individual conductive wire processed as weft thread, are worked into at least one of the knit fabric layers.

The known air-conditioning means for vehicle seats have the disadvantage that, for producing cold or heat, they either require a heat exchanger on board the vehicle, where connecting lines for heated or cooled fluid are necessary, or they need a relatively voluminous heating means for producing heated air. Accordingly, there exists a need for an improved method and device for air conditioning vehicle seats or ventilated components.

### SUMMARY OF THE INVENTION

The present invention provides a compact air-conditioning device for components of a vehicle interior as well as an air-conditioned vehicle seat, which is characterized by compact construction. The present invention also provides a method of air conditioning components of a vehicle interior in which compact construction permits efficient heating of the conveyed air.

An air-conditioning device for components of a vehicle interior, in particular for a vehicle seat, includes a ventilating mechanism for producing an air flow and at least one air duct for connection to an air outlet in and on the component or vehicle seat. The air duct serves to convey the air from the ventilating mechanism to the corresponding component of the vehicle interior. According to a first aspect of the present invention, the air duct has a heating mechanism for heating the conveyed air. The heating mechanism may extend over a specified length of the air duct and preferably comprises at least one electrically heatable heating wire. This heating wire may be located in a direction of extension substantially parallel to the direction of longitudinal extension of the air duct, for example, it may be worked into the latter. The heating wire may alternatively optionally be placed, for example worked into the air duct in the form of a coil. Optionally, the heating wire may extend over the entire length or even over only a part of the length of the air duct. The air-conditioning device according to the invention allows an extremely compact air-conditioning device, variably adaptable to a variety of installation conditions, to be made available for the conveyance of heated air. The length and manner of placement of the heating wire in the air duct defines its heating capacity. In short air ducts, it may be advisable to place the heating wire in coiled form, while in longer air ducts it may be sufficient to use linear heating wires, in order to obtain the desired heating of the air.

The ventilating mechanism may optionally be located at an intake end of the air duct or between an intake end and an outlet end of the air duct. The place of installation of the ventilating mechanism is governed in particular by the spatial conditions prevailing in the vehicle interior. The air-conveying unit may optionally be designed as a radial or axial blower. Here, too, the type of construction is governed first of all by the prevailing spatial conditions as well as by the desired air-conveying capacity.

The conveying capacity of the ventilating mechanism and air-conveying unit may be variably controlled, so that, together with adjustability of the heating capacity of the heating mechanism, sensitive controllability of the conveyed air and its temperature can be obtained. In order to ensure sensitive control of heating capacity, a temperature sensor may be located, for example, on the component in the vehicle interior to be air conditioned, which sensor preferably is located at the outlet of the air duct, for example in the form of negative temperature coefficient (NTC) sensor. With this, the speed and hence the conveying capacity of the blower can be controlled depending upon the temperature of the discharge heated air measured and, together with a suitable characteristic field, regulation of the system and of the heating capacity of the heating mechanism defined. In an air-conveying unit mounted at the end of the heating segment, the temperature sensor may alternatively optionally be integrated into this air-conveying unit.

According to an additional aspect of the present invention, in an air-conditioned vehicle seat with an upholstered seat surface and an upholstered backrest surface, to which is assigned a ventilating mechanism for producing an air flow and at least one air duct that is coupled with an air outlet in the vehicle seat, the air duct has a heating mechanism for heating the conveyed air. The heating mechanism may extend over a specified length or over the entire length of the air duct and comprises at least one heating wire which, according to one of the embodiments previously described, may be worked into the air duct in spiral form or in straight direction along the direction of longitudinal extension of the latter.

The air duct may, in particular, be designed as a flexible hose, into which the heating wires may be injection-molded or cast. Suitable materials for this are, for example, silicone or a suitable synthetic elastomeric material. Optionally, the air duct may alternatively comprise, over its entire length or sectionwise, a stiffer material such as a synthetic thermoplastic material, into which the heating wires may be worked during an injection molding operation.

The ventilating mechanism optionally may be located at an intake end of the air duct of the vehicle seat or between the intake end and the outlet end. Preferably, the at least one air outlet is designed to be closable. For this purpose, the air outlet may in particular have a closable cover, which is coupled with a seat-occupancy detector, so that when a seat is not occupied the cover can be closed.

An additional advantageous embodiment of the invention provides that the air duct runs, at least sectionwise, within the seat cushion and/or the backrest cushion of the vehicle seat. In this way, the unavoidable heat loss of the air duct can be utilized for additional heating of the backrest cushion and the seat cushion. For this purpose, it may be advisable that the air duct be located in regions near the surface of the seat and backrest cushions and installed for example in a meandering or annular form.

An additional advantageous embodiment of the invention provides that the at least one air outlet is coupled with at least one discharge opening that is substantially not covered by a person sitting on the seat. The discharge opening may in particular be located in a transitional region between seat cushion and backrest cushion, also referred to as a gusset. Additional discharge openings may be located for example at left and/or right edge regions of the seat cushion and/or of the backrest cushion, so that an advantageous air-conditioning effect can be secured by the uncovered discharge openings in the direction of the driver and passengers of the vehicle.

In a method according to the invention of air conditioning components of a vehicle interior, in particular a vehicle seat, in which an air flow is produced by a ventilating mechanism and conveyed by at least one air duct to an air outlet in or on the component, for example, the vehicle seat, it is provided that the conveyed air is heated within the air duct. This heating may be effected by a heating wire or, optionally, by a plurality of heating wires connected in parallel. The method according to the invention allows components of a vehicle interior to be air conditioned, in particular heated, in an efficient and space-saving manner without requiring complex heating mechanisms which in addition would have to be thermally insulated and would demand significant space for installation.

An advantageous embodiment of the invention provides that the air outlet is closable and the ventilating mechanism is controllable. In this way, exact control of the temperature and heating capacity of the air-conditioning system of the vehicle components can be ensured.

When a seat is not occupied, it may be provided that the air outlet on the seat is hidden from view.

It may also be provided that a seat-occupied detector produces an adjusting signal and that, as a function thereof, preheating of the seat and the heating mechanism is produced without the heating system being activated by the user. This accelerates the response of the heating mechanism.

Other objects and advantages will become apparent with reference to the following detailed description, taken in conjunction with the accompanying drawings.

### BRIEF DESCRIPTION OF THE DRAWINGS

For a more complete understanding of this invention reference should now be had to the embodiments illustrated in greater detail in the accompanying figures and described below by way of examples of the invention wherein:

FIG. 1 shows a schematic representation of an air-conditioning device according to an embodiment of the invention for components of a vehicle interior.

FIG. 2 shows a first variant of an arrangement of an air duct and ventilating mechanism according to the present invention.

FIGS. 3A and 3B show a second variant of the arrangement of an air duct and ventilating mechanism according to the present invention.

FIG. 4 shows a third variant of the arrangement of an air duct and ventilating mechanism according to the present invention.

FIG. 5 shows a schematic representation of an air-conditionable vehicle seat in accordance with an embodiment of the present invention.

FIG. 6 shows a variant of installation of the air duct in the backrest cushion of the vehicle seat, in schematic representation.

FIG. 7 shows an exemplary variant of an arrangement and design of outlet surfaces in the seat cushion and in the backrest cushion of the vehicle seat in accordance with an embodiment of the present invention.

FIG. 8 shows a schematic representation of a closed air duct when the seat, including an air conditioning device according to the present invention, is not occupied.

FIG. 9 shows a schematic representation of the open air duct when the seat, including an air conditioning device according to the present invention, is occupied.

FIG. 10 shows a schematic diagram showing an exemplary control operation in the air-conditioning device according to an embodiment of the invention.

### DETAILED DESCRIPTION OF THE INVENTION

While the present invention is described with respect to an air conditioning system for the interior of vehicles, the present invention may be adapted and utilized for other ventilated components such as arm rests, door trim, armature panels as well as non-automotive seat and ventilated components applications. In the following description, various operating parameters and components re described for several embodiments. These specific parameters and components are included as examples and are not meant to be limiting.

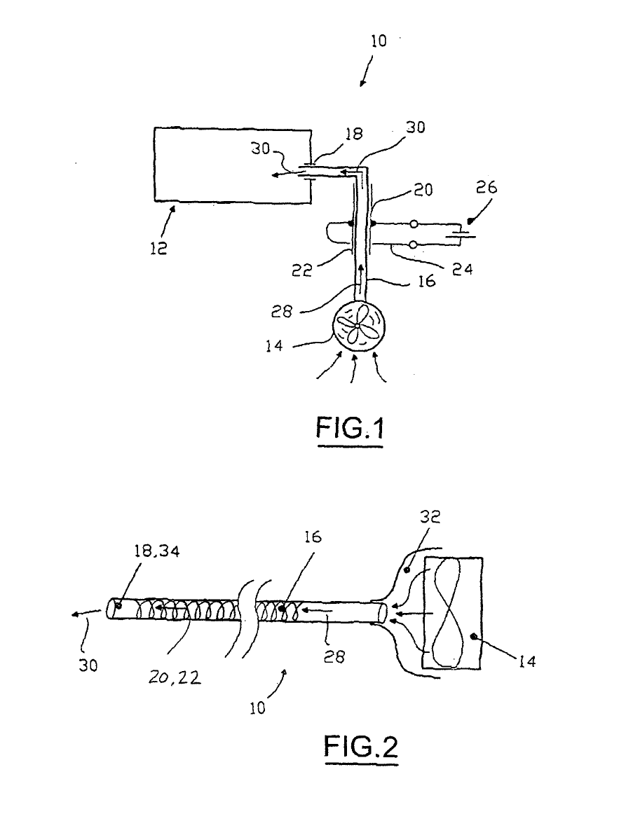

FIG. 1 shows a schematic representation of an air-conditioning device 10 according to an embodiment of the invention, which is in particular suitable for air conditioning components of a vehicle interior, such as for example a vehicle seat 12. The vehicle seat 12 is only indicated in the representation of FIG. 1. Instead of a vehicle seat 12, other components, for example armrests, headrests, a foot space, etc., may alternatively or additionally be air-conditioned.

The air-conditioning device 10 includes a ventilating mechanism 14, which takes in ambient air 28 and conveys it into an air duct 16, which is connected to an outlet 18 that opens into the vehicle seat 12 or component. The outlet 18 may optionally be connected with additional air-distribution mechanisms in the vehicle seat 12, which allow discharge of the heated air 30 at locations provided therefor on the vehicle seat 12 or on its seat or backrest cushion. However, the outlet 18 may alternatively open directly on a surface of the vehicle seat 12, for example in a transitional region between seat and backrest cushions.

The air duct 16 is provided with a heating mechanism 20, which in the exemplary embodiment shown comprises at least one heating wire 22, which is connected via connecting lines 24 with a voltage source 26 of the electrical network of the vehicle. The voltage source 26 is typically a vehicle battery or generator. The ambient air 28 taken in by the ventilating mechanism 14 and conveyed in the air duct 16 is heated in the region of the heating mechanism 20 and flows as heated air 30 through the outlet 18 into and out of the vehicle seat 12.

As mentioned, the heating mechanism 20 may comprise of one or more heating wires 22 that are worked into the air duct 16, which may be done by for example insertion in an injection molding mold and subsequent reinjection with a suitable synthetic thermoplastic and/or elastomeric material. Optionally, the heating wire 22 or the heating wires 22 may run linearly in the direction of longitudinal extension of the air duct 16 as shown in FIG. 1. However, a spiral placement with uniform or variably spaced windings around the periphery of the air duct 16 is alternatively possible. In such a placement, because of closer placement, greater heating capacity can be imparted to the air 28 to be heated.

FIG. 2 shows a first variant of the air-conditioning device 10 according to the invention, in which the ventilating mechanism 14 is located at an intake end of the air duct 16 and the ambient air 28 is conveyed to the other end in the direction of the outlet 18. The ventilating mechanism 14 may at the outlet end preferably have a collector 32, in order to reroute the ambient air 28 favorably in the direction of the air duct 16 and to converge the air into the narrower cross section of the duct. The ventilating mechanism 14 of FIG. 2 is designed as an axial blower. FIG. 2 also shows the heating mechanism 20 in the form of uniformly spaced, spirally arranged heating wires 22. the wires 22 are arranged about the interior surface of the air duct 16.

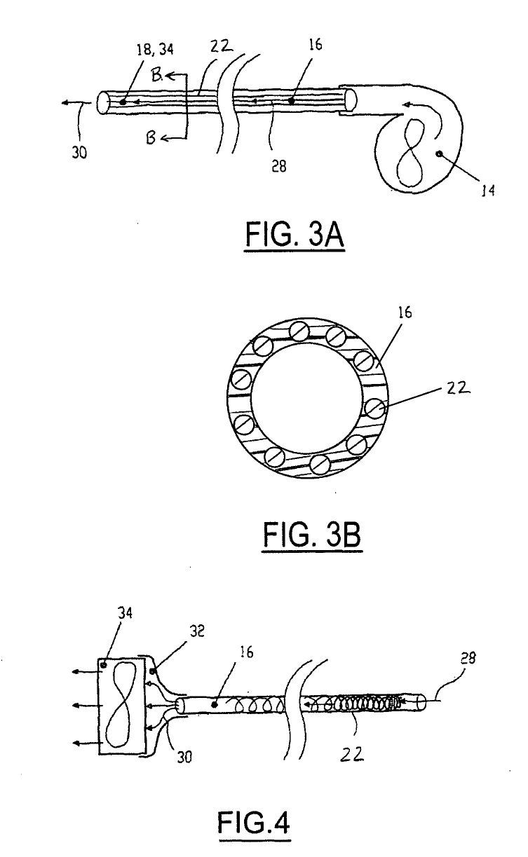

In contrast to FIG. 2, the ventilating mechanism 14 of FIG. 3 has a radial blower. FIGS. 3A and 3B also show the heating mechanism 20 in the form of a plurality of heating wires 22 formed into the air duct 16 by, for example, injection molding the duct 16 with the wires 22 held in the mold. The wires 22 can extend substantially the entire length of the duct 16.

The ventilating mechanism 14 of FIG. 4 has a blower that is located at the outlet end of the air duct 16, so that the other free end of the air duct 16 takes in ambient air 28. The heated air 30 then flows through the axial blower of the ventilating mechanism 14, which takes it in. A temperature sensor 34, which can detect the temperature of the conveyed air 30 and serve to regulate the heating capacity of the air-conditioning device 10, may in addition be located there. Such a temperature sensor 34 is in each instance also indicated in FIGS. 2 and 3 at the outlet 18 of the air duct 16. FIG. 4 also shows the heating mechanism 20 in the form of at least one heating wire 22 which is variably-specially spaced along the interior of the air duct 16. In this example, the wires 22 are more closely spaced at the intake end of the air duct 16 where the coldest air is received. Again, the wires 22 can extend substantially the entire length of the duct 16 or some portion thereof depending upon the particular application under consideration.

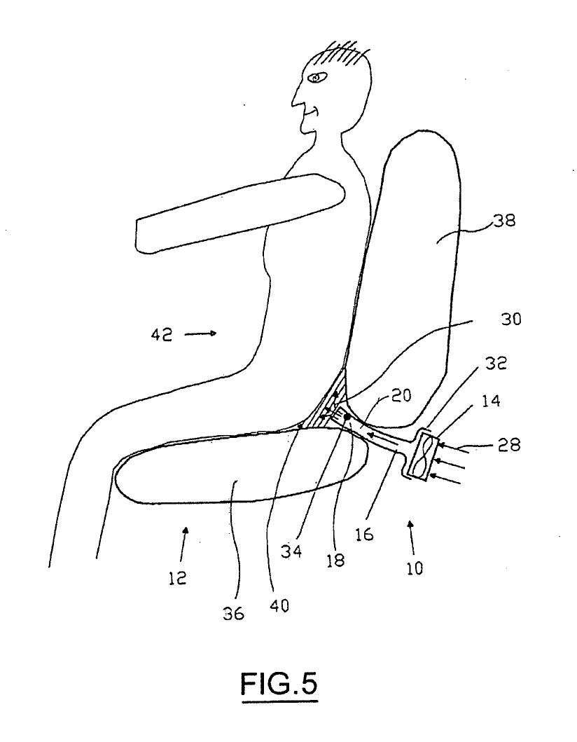

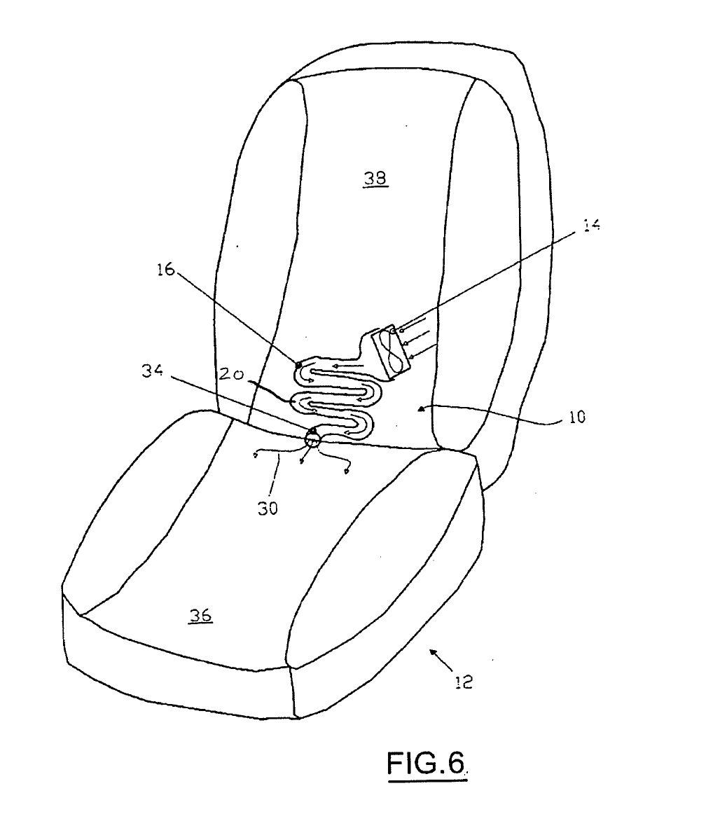

The schematic representation of FIG. 5 shows a possible arrangement of the air-conditioning device 10 on the vehicle seat 12, where the outlet 18 is located in a region between the seat cushion 36 and backrest cushion 38 of the vehicle seat 12. This transitional region 40 is also commonly referred to as the gusset. The advantage of locating the outlet 18 in this transitional region 40 lies in that the outlet 18 cannot be covered by a person sitting on the seat 12 which would clearly detract from the air-conditioning effect. In the representation of FIG. 5, the air duct 16 is very short, so that the ventilating mechanism 14 is located directly behind the seat 12. In application, the air duct 16 would be substantially longer, in order to be able also to apply the desired heating capacity to the air 28 flowing through it.

FIG. 6 shows an advantageous variant of the air-conditioning device 10, in which a meandering section of the air duct 16 is located within the backrest cushion 38, so that the heat loss of the air duct 16 can be used for advantageous additional heating of the backrest cushion 38. Part of the air duct 16 may, in like fashion, optionally or additionally be located in the seat cushion 36, where the air duct 16 should preferably be located in regions near the surface of the seat and backrest cushions in each instance, in order to obtain the desired effect.

In each of the embodiments of FIGS. 5 and 6 shown, the temperature sensor 34 is located in the region of the outlet 18 at which the heated air 30 flows out of the vehicle seat 12 in the direction of the person 42. This is the pertinent measuring point for detection of the temperature of the air-conditioning device to be regulated.

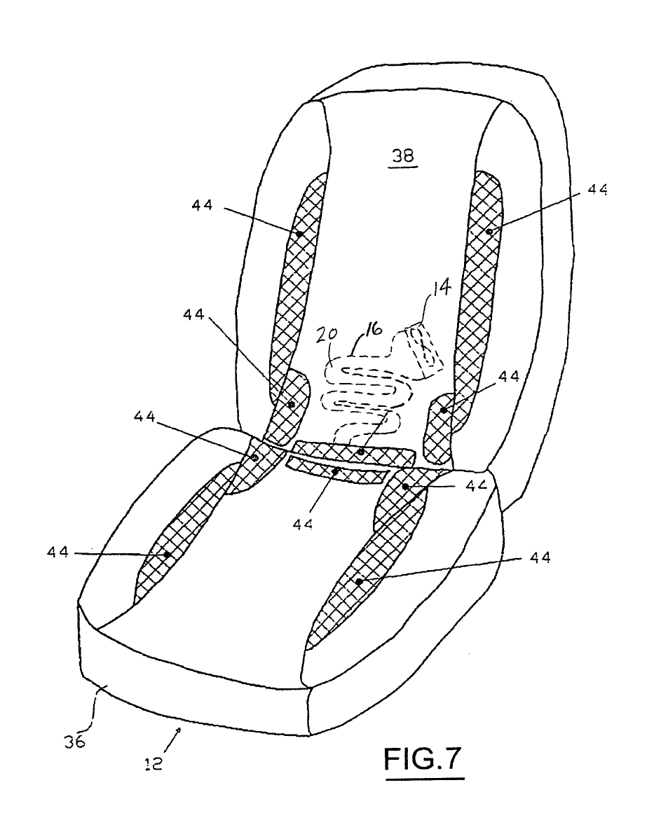

FIG. 7 shows an additional alternative variant of a vehicle seat 12, in which the latter is provided with a variety of additional discharge surfaces 44, which in each instance are connected with the air duct or with a plurality of air ducts. The discharge surfaces 44 are in each instance provided in regions that are not covered by a person 42 sitting on the seat 12. These are longitudinal sides along the seat cushion side edges as well as backrest cushion side edges in regions that lie outside the typical body outline of a person 42 sitting on the seat. Additional discharge surfaces 44 are in turn provided in the vicinity of the transitional region 40 between seat cushion and backrest cushion. The discharge surfaces 44 may optionally be provided with a so-called distance-knit fabric, which can provide better hot air distribution in the region of the seat 12 near the surface underneath the discharge surfaces 44.

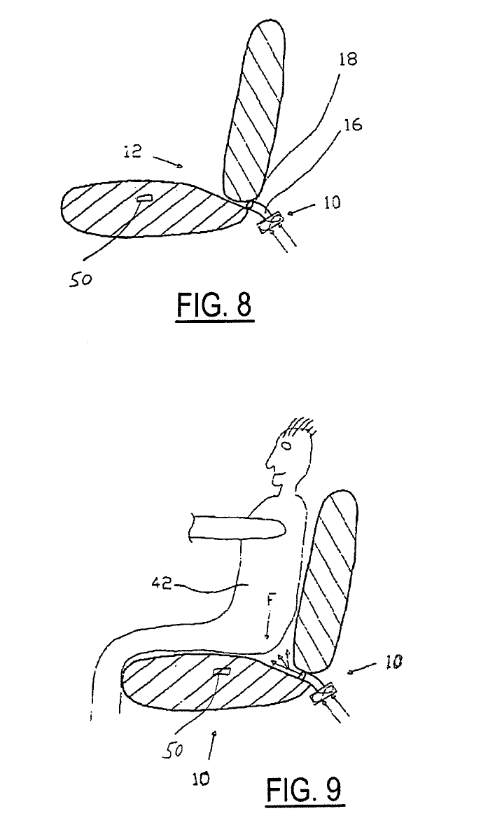

FIGS. 8 and 9 show a variant of the air-conditioning device 10 according to the invention, in which the outlet 18 of the air duct 16 is designed closable. Preferably, a seat-occupancy detector 50 detects whether a person 42 is sitting on the seat 12. When the seat is occupied, the previously closed outlet 18 of the air duct 16 is opened, so that heated air can flow out of it. The advantage of this additional function is that, when the outlet 18 of the air duct 16 is still closed, the air in the duct can already be heated, so that when the air-conditioning device 10 is turned on, a very short response time is made possible.

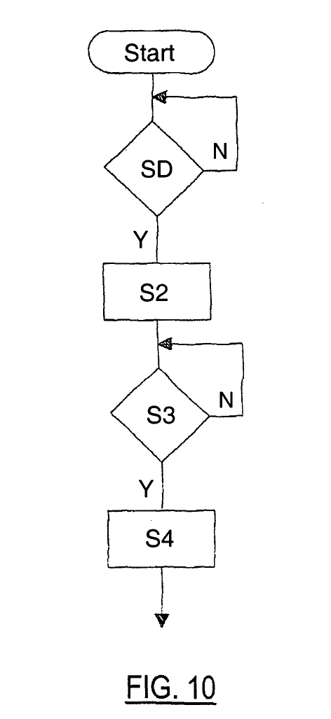

The schematic diagram of FIG. 10 shows how a method according to the invention of air-conditioning components of a vehicle interior, in particular a vehicle seat, functions, in which an air flow is produced by the ventilating mechanism and is conveyed, by at least one air duct, to an air outlet in or on the vehicle seat. After start of the control process, in a first step, the seat-occupancy detector (SD) is queried whether a person is sitting on the seat to be air-conditioned. If so, in a step S2 the heating mechanism 20 is activated in order to preheat the system. Preferably, the system also determines whether the temperature of the passenger compartment lies under a minimum temperature, such as approximately 5° C. Logically, preheating takes place only when the temperature falls below this minimum.

In a subsequent step S3, it is queried whether the user has activated the air-conditioning device. Only when this is the case, in a step S4 is the ventilating mechanism activated and, optionally, its speed as well as the heating capacity of the heating mechanism regulated. The queries of steps 1 and 3 are customarily always made, since the control system is intended to react to desired temperature or heating capacity specifications with a short response time.

While the invention has been described in connection with one or more embodiments, it is to be understood that the specific mechanisms and techniques which have been described are merely illustrative of the principles of the invention, numerous modifications may be made to the apparatus described without departing from the spirit and scope of the invention as defined by the appended claims.

1. An air-conditioning device for components of a vehicle interior comprising:
a ventilating mechanism for producing an air flow and having at least one air duct for connection to an air outlet of the component, the air duct comprising a heating mechanism for heating the air flowing through the duct, the heating mechanism extending over a given length along a wall of the air duct.

2. An air-conditioning device according to claim 1, wherein the heating mechanism is accommodated in the wall of the air duct and comprises at least one heating wire.

3. An air-conditioning device according to claim 2, wherein the at least one heating wire is arranged spirally along the wall of the air duct.

4. An air-conditioning device according to claim 3, wherein the spirals of at least one heating wire are variably spaced.

5. An air-conditioning device according to claim 1, wherein the ventilating mechanism is located at an intake end of the air duct or between the intake end and an outlet end of the air duct.

6. An air-conditioning device according to claim 1, wherein the air outlet is closable.

7. An air-conditioning device according to claim 2, wherein the ventilating mechanism is located at an intake end of the air duct or between the intake end and an outlet end of the air duct.

8. An air-conditioning device according to claim 1, wherein the ventilating mechanism comprises at least one of a radial blower, axial blower or a fan.

9. An air-conditioned vehicle seat comprising:
an upholstered seat surface;
an upholstered backrest surface;
a ventilating mechanism for producing an air flow; and
at least one air duct which is coupled with an air outlet in the vehicle seat, the air outlet being in fluid communication with at least one of the seat surface or backrest surface wherein the air duct comprises a heating mechanism for heating the air flowing through the duct, the heating mechanism extending over a given length and along a wall of the air duct.

10. An air-conditioning device according to claim 9, wherein the heating mechanism is accommodated in the wall of the air duct and comprises at least one heating wire.

11. An air-conditioning device according to claim 10, wherein the at least one heating wire is arranged spirally along the wall of the air duct.

12. An air-conditioning device according to claim 11, wherein the spirals of at least one heating wire are variably spaced.

13. An air-conditioned vehicle seat according to claim 9, wherein the ventilating mechanism is located at an intake end of the air duct or between the intake end and an outlet end of the air duct, wherein the air outlet is coupled with at least one discharge opening arranged so as not to be covered by a person sitting on the seat, and wherein the at least one discharge opening is located in a transitional region between the seat cushion and the backrest cushion or an edge region of the seat cushion or of the backrest cushion.

14. An air-conditioned vehicle seat according to claim 10, wherein the ventilating mechanism is located at an intake end of the air duct or between the intake end and an outlet end of the air duct, wherein the air outlet is coupled with at least one discharge opening arranged so as not to be covered by a person sitting on the seat, and wherein the at least one discharge opening is located in a transitional region between the seat cushion and the backrest cushion or an edge region of the seat cushion or of the backrest cushion.

15. An air-conditioned vehicle seat according to claim 9, comprising a seat occupancy detector, and wherein the air outlet is closeable as a function of an output of said detector.

16. An air-conditioned vehicle seat according to claim 9, wherein the air duct runs, at least sectionwise, within the seat cushion or the backrest cushion of the vehicle seat.

17. A method of operating an air-conditioned vehicle seat according to claim 9 comprising the steps of preheating the air within the air duct when the seat is unoccupied and, in response to detecting seat occupancy, activating the ventilating mechanism to convey the preheated air through the air duct.

18. A method of operating an air-conditioned vehicle seat according to claim 15 comprising the steps of closing the air outlet when the seat is unoccupied and, in response to detecting seat occupancy, opening the closing mechanism and activating the ventilating mechanism to convey air through the air duct.
